(19) United States
(12) Patent Application Publication
(10) Pub. No.: US 2009/0327077 A1
(43) Pub. Date: Dec. 31, 2009

(54) ADVERTISING SERVICE METHOD PROVIDING SEPARATE ADVERTISEMENT OF MOVING PICTURE DURING THE GAME PLAY AND SYSTEM THEREOF

(75) Inventor: Do-Sung Kim, Seoul (KR)

Correspondence Address: Muncy, Geissler, Olds & Lowe, PLLC, P.O. BOX 1364, FAIRFAX, VA, 22038-1364, US

(73) Assignee: ARUON GAMES INC., Seoul (KR)

(21) Appl. No.: 12/514,100

(22) PCT Filed: Nov. 8, 2007
(86) PCT No.: PCT/KR2007/005613

§ 371 Date: May 8, 2009

(30) Foreign Application Priority Data
Nov. 8, 2006 (KR) 10-2006-0109918
Jul. 12, 2007 (KR) 10-2007-0070080

(51) Int. Cl. G06Q 30/00; G06F 15/16; G06Q 50/00

(52) U.S. Cl. 705/14.53; 705/14.59; 705/14.66; 709/204; 715/760

(57) ABSTRACT

Provided are an advertising service providing method and advertising service providing system for providing a separate video advertisement once a video game is paused. The advertising service providing method includes pausing a game in a terminal if a predetermined first condition is satisfied while the video game is being played in the terminal; outputting an advertisement including video data once the video game is paused; and resuming the video game once the advertisement is completely output. According to the present invention, by pausing a game when the concentration of users is high and primarily outputting an advertisement that is separate from the game, the advertisement may be noticed and effectively advertised, and users may use the video game for free or at an inexpensive price as a result of employing this effective form of advertising since a game provider may a stably profit from advertisement fees paid by an advertiser.

### TECHNICAL FIELD

The present invention relates to an advertising service for providing a separate video advertisement once a game is paused, and more particularly, to an advertising service providing method and advertising service providing system for providing a separate advertisement in a video format to a user terminal once a game is paused if a predetermined condition is satisfied while the game is being played.

### BACKGROUND ART

Currently, the demands and supplies in the video game market have explosively increased greater than any time in the past. Various game competitions are held in Korea and other countries, television programs on video games have become popular, becoming a pro-gamer has recently become a very popular occupation, and the private lives of famous pro-gamers is reported on dailies.

As the interest on video games increases and the users playing video games diversifies, many advertisers are interested in effectively advertising by means of the video games.

In a conventional advertising method, an advertisement is provided before a game is started, however, the advertisement is not noticed by or hardly draws interest from the users.

In another conventional advertising method, a product to be advertised is incorporated into the actual video game as a background or an item of the actual video game. For example, in a soccer video game, products or trademarks may be incorporated onto uniforms of players or signboards of a stadium by using graphic images.

As another example, in a role-playing game, if a character of the role-playing game enters into a store and purchases an item, advertising is performed using the item. For example, if a character of a role-playing game enters into a store to purchase a car, which is necessary for the game, the purchased car is of an actual brand or a design of an actual car, and thus, the advertising is effectively performed by using the actual brand of an actual car as the purchased car.

However, by using other conventional advertising methods, items to be advertised are not effectively advertised by means of the game. Thus, effective advertising may be restrictive and the users may not notice or be interested in the advertisement.

Also, game providers may not stably profit from on-line or off-line games due to copyright infringement.

In the case of off-line games, such as software games, copyright infringement is frequently performed by copying CD keys or by hacking the program code. In the case of on-line games, although the on-line games have been developed with a large cost, if a free open-beta service is initially provided and then once the free open-beta service is changed to a charge service, most users that were previously using the free open-beta service stop accessing the video game and only 10% of them continue to access the video game.

As such, most domestic small game developers and providers may be affected financially since the development of high quality games may be assigned instead to abroad game developers such as developers in China. Therefore, the competitiveness of the domestic game developers has decreased.

### DESCRIPTION OF THE DRAWINGS

FIG. 1 is a functional block diagram of a structure of an advertising service providing system according to an embodiment of the present invention;

FIG. 2 is a functional block diagram of a structure of an advertising service providing system according to another embodiment of the present invention;

FIG. 3 is a temporal conceptual view of an advertising service according to an embodiment of the present invention;

FIG. 4 is a spatial conceptual view of an advertising service according to an embodiment of the present invention;

FIG. 5 is a flowchart of an advertising service providing method performed by a terminal, illustrated in FIG. 1, which provides an advertising service by itself without being connected to an advertisement server through a communication network, according to an embodiment of the present invention;

FIG. 6 is a flowchart of an advertising service providing method performed by a terminal and an advertisement server, illustrated in FIG. 2, which provide an advertising service in cooperation with each other, according to an embodiment of the present invention;

FIG. 7 is a photographic image of the screen when a game is being played, according to an embodiment of the present invention;

FIG. 8 is a photographic image of the screen when an advertisement is output in a window once the game is paused, according to an embodiment of the present invention; and

FIG. 9 is a photographic image of the screen when a game is resumed once the advertisement is completely output, according to an embodiment of the present invention.

### DETAILED DESCRIPTION OF THE INVENTION

### Technical Problem

The present invention provides an advertising service providing method and advertising service providing system for providing a separate video advertisement once a game is paused.

In particular, the present invention provides an advertising service providing method and advertising service providing system for providing a separate video advertisement on a dialog box of a user terminal once a game is paused, and thus, effectively advertising to users playing the video game that may be provided to the users for free or at a discount due to advertising fees paid by an advertiser to a game provider.

### Technical Solution

According to an aspect of the present invention, provided is an advertising service providing method by which a separate video advertisement is provided once a game is paused, the advertising service providing method comprises pausing a game displayed in a terminal if a predetermined first condition is satisfied while the video game is being played in the terminal; outputting an advertisement including video data once the video game is paused; and resuming the video game once the advertisement is completely output.

### Advantageous Effects

According to the present invention, the visibility and effect of an advertisement including video data may be greatly increased in comparison with a conventional product placement in game (PPG) service, by effectively advertising once a game is paused since, at that moment, the attention and concentration level of the users is high due to playing of the game.

Thus, users may access a game for free or at a lower cost due to advertisement fees paid by an advertiser to a game provider.

Additionally, the likeliness that users stop using the video game once the video game is changed to a charge service from a free beta-test service is low since the game charges may be low or non-existent if advertising fees paid by an advertiser are sufficient to a game provider, and thus, this may stably develop and provide the video game.

Furthermore, according to the present invention, a big difference may not exist between a free-beta test game and a charged game and a game may be provided for free or at an inexpensive price. Thus, a greater number of users may use the video game than the number of current users using the free beta-test game and the game industry may be promoted.

### Mode of the Invention

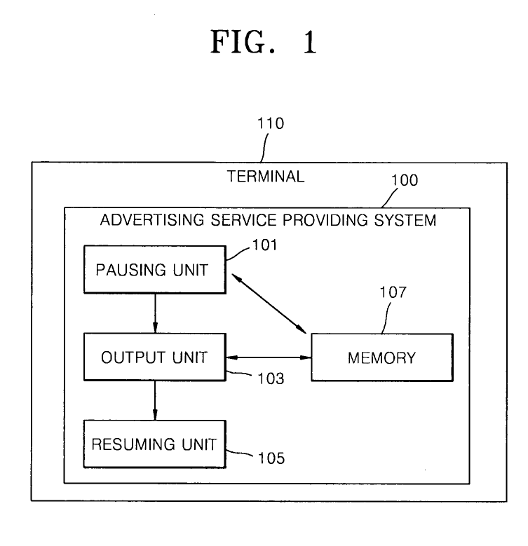

FIG. 1 is a functional block diagram of a structure of an advertising service providing system 100 according to an embodiment of the present invention.

Referring to FIG. 1, the advertising service providing system 100 includes a pausing unit 101, an output unit 103, a resuming unit 105, and a memory 107. The advertising service providing system 100 is included in a terminal 110 that operates the advertising service providing system 100 itself without being connected to an advertisement server through a communication network.

The pausing unit 101 pauses a video game (hereinafter referred to as “game”) if a predetermined first condition is satisfied while the game is being played in the terminal 110. The pausing unit 101 may pause the game by obtaining control of the game program by suspending all threads composing the game or interrupting execution of a predetermined function, which is being executed while the game is being played, or executing another predetermined function to pause the game program and which is included in the game program.

The predetermined first condition may be an output condition of a previously stored advertisement. In this case, the advertising service providing system 100 determines whether the predetermined first condition is satisfied in the terminal 110 without any connection with an external server such as the advertisement server.

The output condition of the advertisement is previously stored in the memory 107 of the terminal 110. The output condition of the advertisement may relate to a predetermined point of time or a predetermined step of the game. For example, the pausing unit 101, in cooperation with the memory 107, may pause the game by determining whether a predetermined period of time is passed after the game is started, whether an important event signal of the game is generated in the terminal 110, whether a signal regarding a point of time when chapters or sections of the game are changed is generated, or whether a previously set pausing time is reached.

The output unit 103 outputs the advertisement including video data once the game is paused by the pausing unit 101. All or a part of the advertisement is previously stored in the memory 107 before the game is paused and the output unit 103 outputs the advertisement stored in the memory 107.

The advertisement may be the same as a television (TV) commercial. In the present embodiment, the advertisement is forcibly provided while the game is being played. Accordingly, a user may not prevent the advertisement from being output in the present embodiment; however the TV commercial may be prevented from being totally output by simply changing the channel.

The resuming unit 105 resumes the game once the advertisement is completely output by the output unit 103. The resuming unit 105 resumes the game from a point of time when the game was paused, by activating the threads previously suspended by the pausing unit 101 or resuming execution of the predetermined function, which is being executed while the game is being played, from the point where the predetermined function was interrupted to pause the game by the pausing unit 101.

In the present invention, the paused game may be resumed only if the user normally and completely views the advertisement. Accordingly, the advertisement may include a dialog box for inputting user data.

The dialog box may request the user for confirmation whether the advertisement was viewed or whether the user wants to resume the game, or may request the user with a subjective or objective question regarding the advertisement.

In this case, the resuming unit 105 may resume the game only if the user data is correct.

For example, the resuming unit 105 may determine whether the user data is correct by determining if the user data is identical to answer data that is previously stored in the memory 107.

The resuming unit 105 may not resume the game if the user data is not correct. In this case, the resuming unit 105 may repeatedly request the user for inputting user data until the user input is correct or may control the output unit 103 to output the advertisement again.

The memory 107 of the terminal 110 may be a general memory device and may store the executable file of the game, game data, the advertisement to be output by the output unit 103, and the predetermined first condition for pausing the game. Also, if the advertisement includes the dialog box for inputting user data, the memory 107 may previously store data required for determining whether the user data is correct.

The present invention may be realized by a program included in the executable file of the game to which the advertisement is provided, by modulating the executable file of the game or by a program included in a control file that is separate from the executable file of the game.

If the present invention is realized by the program included in the control file that is separate from the executable file of the game, the program may be loaded by a third program that is controlled also with the executable file of the game after the executable file of the game is loaded. On the other hand, the executable file of the game may be loaded by the program included in the control file.

FIGS. 7, 8, and 9 are photographic images illustrating windows of a separate video advertisement provided by the advertising service providing system 100 illustrated in FIG. 1 once a game is paused, according to an embodiment of the present invention. The windows of the separate video advertisement illustrated in FIGS. 7, 8, and 9 are captured from an actual advertisement of actually playing the game. FIGS. 7, 8, and 9 will be described in conjunction with FIG. 1.

FIG. 7 is a photographic image of a screen when the game is played on the terminal 110. If a predetermined first condition is satisfied while the game is being played, the pausing unit 101 pauses the game.

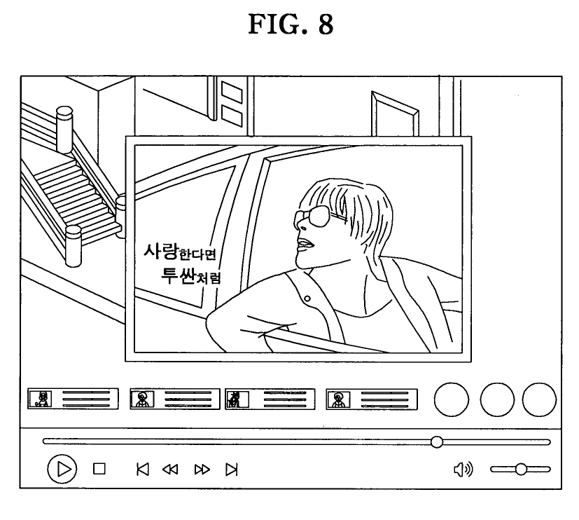

FIG. 8 is a photographic image of the screen when the advertisement including video data is output by the output unit 103 in a window once the game is paused by the pausing unit 101. In FIG. 8, the advertisement corresponds to a TV commercial of the TUCSON™ vehicle by Hyundai Motor Company™.

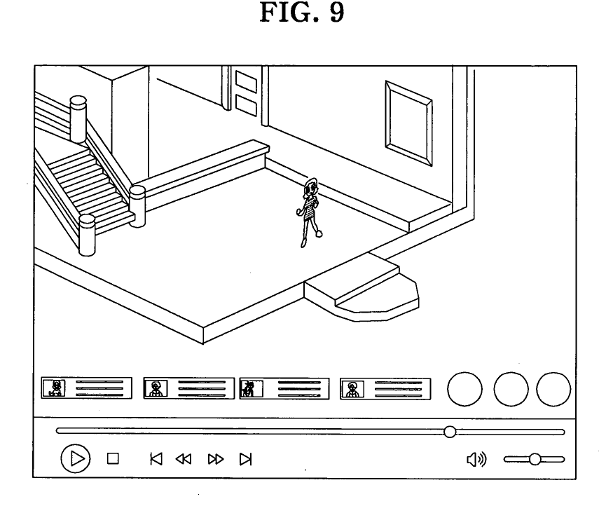

FIG. 9 is a photographic image of the screen when the game is resumed by the resuming unit 105 once the advertisement is completely output. According to the current embodiment, the screens and the window of FIGS. 7, 8, and 9 are sequentially provided to a user.

Referring to FIG. 1, the terminal 110, to which the advertising service providing system 100 is applied, may be one of various platforms. That is, the terminal 110 may be a personal computer (PC), a notebook computer, a terminal for mobile communication in which a mobile game is executable, or a home terminal for console games in which a game is playable by using a TV.

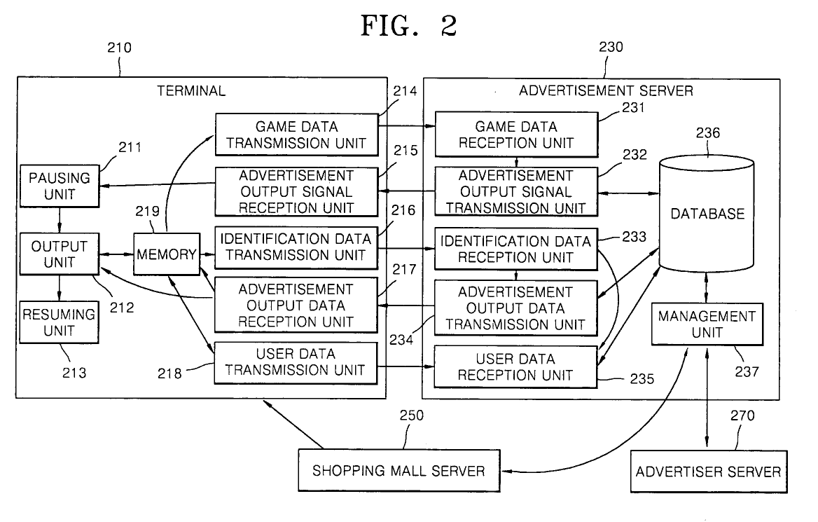

FIG. 2 is a block diagram of a structure of an advertising service providing system according to another embodiment of the present invention.

Referring to FIG. 2, the advertising service providing system may provide an advertising service with a terminal 210, an advertisement server 230, a shopping mall server 250, and an advertiser server 270.

The terminal 210 includes a pausing unit 211, an output unit 212, a resuming unit 213, a memory 219, a game data transmission unit 214, an advertisement output signal reception unit 215, an identification data transmission unit 216, an advertisement output data reception unit 217, and an user data transmission unit 218.

The advertisement server 230 includes a game data reception unit 231, an advertisement output signal transmission unit 232, an identification data reception unit 233, an advertisement output data transmission unit 234, a user data reception unit 235, a database 236, and a management unit 237.

In the present invention, if a predetermined first condition is stored in the memory 219, the pausing unit 211, in coordination with the memory 219, may determine whether the predetermined first condition is satisfied to pause a game. However, whether to pause the game may be actually determined by the advertisement server 230.

In order to determine whether to pause the game by the advertisement server 230, the game data transmission unit 214 refers to the memory 219 and transmits data regarding a playing situation of the game to the advertisement server 230 that determines a point of time when an advertisement is to be output. The data regarding the playing situation may include information regarding actual game played time, or temporal or spatial positions of the game.

The advertisement output signal reception unit 215 receives an advertisement output signal indicating to pause the game and to output the advertisement that is transmitted from the advertisement server 230 if the data regarding the playing situation and which is transmitted from the game data transmission unit 214 satisfies a predetermined second condition stored in the advertisement server 230.

In this case, the predetermined second condition is previously stored in the database 236 of the advertisement server 230. The predetermined second condition may relate to a predetermined point of time or a predetermined step of the game.

For example, the advertisement server 230 may transmit the advertisement output signal indicating to pause the game and to output the advertisement, by determining whether a predetermined period of time is passed after the game is started, whether an important event signal of the game is generated, or whether the game reaches a point of time when chapters or sections of the game are changed, from the data regarding the playing situation and which is transmitted from the game data transmission unit 214.

The advertisement output signal reception unit 215 receives the advertisement output signal and notifies the pausing unit 211 that the advertisement output signal is received. In this case, the predetermined first condition is satisfied if the advertisement output signal reception unit 215 receives the advertisement output signal from the advertisement server 230.

That is, if the advertisement output signal is received from the advertisement server 230 and is transferred to the pausing unit 211, the pausing unit 211 pauses the game. Thus, a point of time when the advertisement is to be output is actually determined by the advertisement server 230.

In the present invention, the game may be an on-line or off-line game. Here, the off-line game may be played without being connected to a communication network while the on-line game may be played by being connected to an external system through a communication network.

The identification data transmission unit 216 transmits user identification data regarding users using the game to the advertisement server 230. The users may be identified or searched by using the user identification data such as user identifications (IDs). The user identification data may be input by the user at a point of time when the game starts to be played or may be previously stored in the memory 219.

In the present invention, when a plurality of advertisements are output, an advertising of an item may be performed so that priorities of the advertisements may be determined in accordance with information regarding the users using the game and the advertisements are output in accordance with the priorities. Thus, the identification data transmission unit 216 transmits the user identification data to the advertisement server 230.

The advertisement output data reception unit 217 receives data, regarding an advertisement selected by user information searched by using the user identification data of the advertisement server 230, or data, regarding priorities of the advertisements which are determined in accordance with information regarding the searched users, from the advertisement server 230 and stores, in the memory 219, the data, regarding the selected advertisement or the data regarding the priorities of the advertisements, or transfers the data, regarding the selected advertisement or the data regarding the priorities of the advertisements, to the output unit 212.

The advertisements to be output at a point of time when the game is paused by the pausing unit 211 and the data regarding the priorities of the advertisements may be previously stored in the memory 219. In this case, the output unit 212 sequentially outputs the advertisements in accordance with the data regarding the priorities of the advertisements and which is received from the advertisement output data reception unit 217 or is searched for in the memory 219.

Regardless whether the advertisements are previously stored or are not previously stored in the memory 219, the output unit 212 may primarily output an advertisement received in real time from the advertisement server 230 once the game is paused and before the advertisements are output.

For example, the priorities of the advertisements are determined as described below.

It is assumed that the predetermined first condition is satisfied three times while the game is being played once. In this case, an advertisement may be repeatedly output three times. However, three advertisements, which have first through third priorities, from among ten advertisements may be sequentially output.

If the user wants to play a quick game or does not want to play the game continuously and thus the predetermined first condition is satisfied only once, the advertisement having the first priority may be output.

In the advertising service providing system in which the advertisements are sequentially output in accordance with the priorities by cooperation between the terminal 210 and the advertisement server 230, the advertisements may include data that enables the users using the game to access Internet sites relating to items being advertised. In the present invention, an advertisement including video data may include a dialog box for inputting user data.

The dialog box may provide questions relating to the items being advertised, an application form, or a consent form as well as additional explanation about the advertisement, or may request the user to fill the application form or the consent form.

User data obtained by using the dialog box, that is, user data regarding the questions relating to the items being advertised, the application form, or the consent form, may be stored in the memory 219 and then may be used as a condition for selecting a subsequent advertisement to be output next time.

The user data transmission unit 218 extracts the user data from the memory 219 and transmits the user data to the advertisement server 230.

Elements of the advertisement server 230 will now be described.

The game data reception unit 231 receives the data, regarding the playing situation of the game being played in the terminal 210, from the game data transmission unit 214 of the terminal 210 and transfers the data regarding the playing situation to the advertisement output signal transmission unit 232.

If the data regarding the playing situation satisfies a predetermined condition, the advertisement output signal transmission unit 232 transmits the advertisement output signal to the advertisement output signal reception unit 215 of the terminal 210 in order to pause the game and to output the advertisement including video data in the terminal 210.

The predetermined condition may relate to whether a predetermined period of time is passed after the game is started, whether an important event signal of the game is generated, and whether the game reaches a point of time when chapters or sections of the game are changed, and may be previously stored in the database 236 before being determined by the advertisement output signal transmission unit 232. The advertisement output signal transmission unit 232 refers to the database 236 in order to determine whether the data regarding the playing situation satisfies the predetermined condition.

The identification data reception unit 233 receives the user identification data from the identification data transmission unit 216 of the terminal 210 and transfers the user identification data to the user data reception unit 235 or the advertisement output data transmission unit 234.

If the advertisement output by the terminal 210 includes the dialog box for inputting user data, the user data reception unit 235 receives the user data obtained by using the dialog box from the user data transmission unit 218. The dialog box may request the user to answer questions relating to the items being advertised, or to fill an application form or a consent form.

The user data reception unit 235 searches the database 236 for user data indicated by the user identification data that is transferred from the identification data reception unit 233 and then updates the user data by using the user data received from the user input transmission unit 218.

As such, in the present invention, the item being advertised may be advertised more efficiently. For example, if the user inputs new user data regarding a new hobby of the user for the questions provided on the screen, the user data reception unit 235 updates the user data, regarding hobbies, which is previously stored in the database 236.

The advertisement output data transmission unit 234 searches the database 236 for the user data indicated by the user identification data that is transferred from the identification data reception unit 233.

The advertisement output data transmission unit 234 may select an advertisement in accordance with the user data searched for in the database 236 and may transmit the selected advertisement to the advertisement output data reception unit 217 of the terminal 210 so as to primarily output the selected advertisement by the terminal 210.

The user data may be previously stored in the database 236 before being searched for in the database 236. The user data may include information regarding purchase preference, age, gender, living location, and interest of the user and which is input when the user agrees to use an advertising service according to the present invention or fills a registration form of an on-line game for membership.

The database 236 may also store advertisement data that is set by the advertiser. The advertisement data may include information regarding purchase preferences, ages, genders, living locations, and interests of desirable users who are the target users of the advertisement. Furthermore, the database 236 may store a user list of users selected by the advertiser as targets of the advertisement. The management unit 237 may receive the advertisement data or the user list from the advertiser server 270 and may previously store the advertisement data or the user list to the database 236.

The advertisement output data transmission unit 234 compares the user data to the advertisement data and selects an advertisement that mostly corresponds to the user data in order to transmit the advertisement to the terminal 210 of the user.

The advertisement output data transmission unit 234 may also select an advertisement as described below.

If the user data regarding personal information such as hobbies, addresses, and genders of users is indexed in accordance with numbers or symbols which are assigned to each user, and the indexed data is stored in the database 236, the management unit 237 extracts the indexed data from the database 236 and transmits the indexed data to the advertiser server 270.

The advertiser server 270 refers to the personal information included in the indexed data, selects advertisements which are desired to be transmitted for each indexed user number, generates the advertisement list, and transmits the advertisement list to the advertiser server 270 that stores the advertisement list in the database 236.

The advertisement output data transmission unit 234, in coordination with the database 236, selects and transmits a predetermined advertisement to a user searched in accordance with the advertisement list that is transmitted from the advertiser server 270 based on the indexed data.

The advertisement output data transmission unit 234 may transmit the data regarding the priorities of the advertisements instead of the advertisement. The advertisement output data transmission unit 234 determines the priorities of the advertisements in accordance with the user data that is searched by using the user identification data that is transferred from the identification data reception unit 233. The advertisement output data transmission unit 234 transmits the data regarding the priorities of the advertisements to the advertisement output data reception unit 217 of the terminal 210 in order to output the advertisements by the terminal 210 in accordance with the priorities of the advertisements.

The priorities of the advertisements may be determined by using a similar method to the method used when the advertisements are selected in accordance with the user data as described above. That is, the advertisement output data transmission unit 234, in coordination with the database 236, may determine the priorities of the advertisements by comparing the advertisement data with, for example, the information regarding the purchase reference which is included in the user data.

The advertisement output data transmission unit 234, in coordination with the database 236, may also determine the priorities of the advertisements in accordance with the advertisement list for each user by determining whether a searched user is included in the advertisement list that is transmitted from the advertiser server 270.

As described above, the advertisements may include data that enables the users using the game to access Internet sites relating to the items being advertised. The user data stored in the database 236 includes information regarding whether the users have accessed the Internet sites or information regarding purchasing inclination of the users in the Internet sites.

The management unit 237, in cooperation with the shopping mall server 250, updates the user data stored in the database 236. The updating of the user data by the management unit 237 and the shopping mall server 250 will now be described in detail.

The user data searched by using the user identification data that is received from the identification data transmission unit 216 may include the information regarding whether the users have accessed the Internet sites or the information regarding purchasing inclination of the users in the Internet sites, such as the types or quantities of products purchased by the users and shopping time of the users.

For example, the advertisements may include data that enables the terminal 210 to access the shopping mall server 250 by using a method in which the Internet sites relating to the items being advertised are opened as new windows if the users click a certain region of the dialog box with a mouse.

The users may only visit the Internet sites or may purchase desired products provided by the Internet sites. The shopping mall server 250 transmits the information, regarding whether the users have accessed the shopping mall server 250 by using the advertisements or the information regarding purchasing inclination of the users, to the management unit 237 of the advertisement server 230. The information regarding purchasing inclination may include the types, quantities, or prices of the products purchased by the users.

The management unit 237 updates the user data stored in the database 236 based on the information regarding whether the users have accessed the Internet sites or the information regarding purchasing inclination of the users in the Internet sites and which are received from the shopping mall server 250. By using the updated user data, the advertisement output data transmission unit 234 of the advertisement server 230 may check the purchasing inclination of the users more correctly such that the item being advertised may be advertised more accurately.

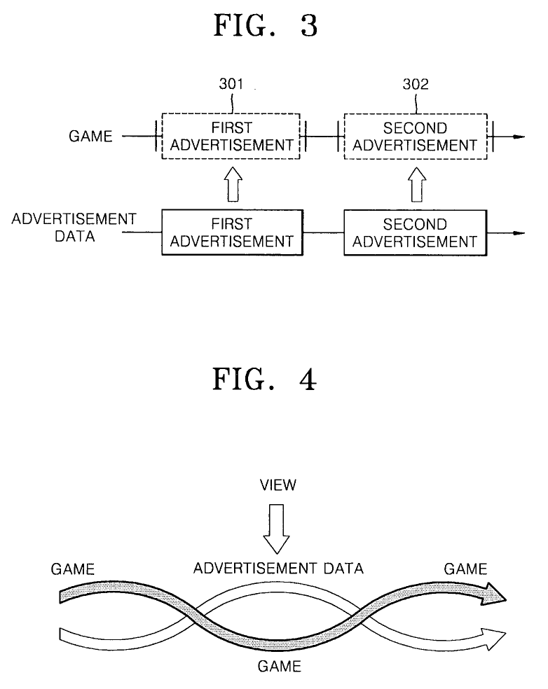

FIG. 3 is a temporal conceptual view of an advertising service according to an embodiment of the present invention.

Hereinafter, a conventional advertising service and the advertising service, according to the present invention, in games will be compared and be described in more detail.

In general, the conventional advertising service such as PPG disposes a signboard, a brand name, or a trademark of an advertiser on a space such as a background, a wall, or a signboard in a game. That is, a game producer produces graphic or text data to be inserted in the game in accordance with a request of the advertiser, and displays the graphic or text data in the game so as to advertise to users while the game is being played.

However, according to the advertising service of the present invention, an advertisement is not included in the game and is provided separately from the game once the game is paused, as illustrated in FIG. 3.

While the game is being played, a first advertisement is provided by an output unit for a period 301 of time when the game is paused by a pausing unit, and then, the game is resumed when the first advertisement is completely provided. Then, once the resuming unit resumes the game, a second advertisement is provided by the output unit for a period 302 of time when the game is paused again by the pausing unit, and then, the game is resumed when the second advertisement is completely provided.

FIG. 4 is a spatial conceptual view of an advertising service according to an embodiment of the present invention. FIG. 4 will be described in conjunction with FIG. 2.

FIG. 4 illustrates a spatial concept in which output positions of a game and an advertisement are switched with each other while the game is being played. That is, in view of a user, game data and advertisement data are completely separate. In general, the game data is provided for a view of the user while the game is being played. However, at a predetermined point of time or at a predetermined place, the advertisement data is provided instead of the game data for the view of the user by cooperation of the pausing unit and the output unit.

Game contents to which the present invention is applied may be provided to a user in a package or may be stored in the database 236 of the advertisement server 230 so as to be provided to the user online and upon a request of the user, in accordance with a circuit environment of the terminal 210 of the user, or a commercial determination of a game content developer or provider. A providing method of the game contents may be selected by the developer or the user.

Also, the game contents to which the present invention applies include a packaged game or a single game, which do not require on-line competition or cooperation with other users. In the single game, data regarding a playing situation is stored online from the terminal 210 to the advertisement server 230 for each user, and the user may load the data regarding the playing situation from the advertisement server 230 to the terminal 210. Accordingly, the single game may be freely moved or accessed such that the user may continuously play the game from where the game is paused although a game playing location or the terminal 210 is changed.

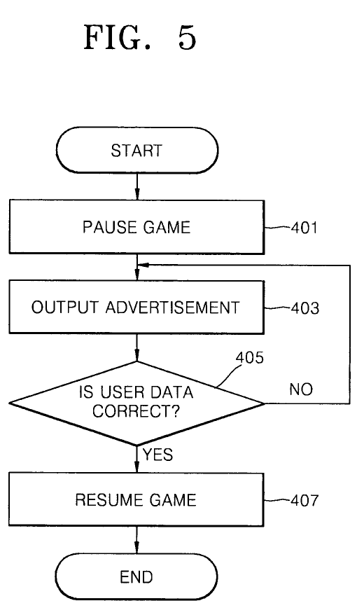

FIG. 5 is a flowchart of an advertising service providing method performed by the terminal 110, illustrated in FIG. 1, which provides an advertising service by itself without being connected to an advertisement server through a communication network, according to an embodiment of the present invention. FIG. 5 will be described in conjunction with FIG. 1.

Referring to FIG. 5, the pausing unit 101 pauses a game if a predetermined first condition is satisfied while the game is being played in the terminal 110, in operation 401. The predetermined first condition may be an output condition of an advertisement and may relate to a predetermined point of time or a predetermined step of the game. The predetermined first condition is previously stored in the memory 107 of the terminal 110. The pausing unit 101, in cooperation with the memory 107, may determine whether to pause the game.

The output unit 103 outputs the advertisement including video data once the game is paused by the pausing unit 101, in operation 403. The advertisement is previously stored in the memory 107 before the game is paused and the output unit 103 outputs the advertisement stored in the memory 107.

If the advertisement includes a dialog box for inputting user data and the user correspondingly inputs user input, the resuming unit 105 determines whether the user data is correct, in operation 405. If the user data is correct, the resuming unit 105 resumes the game that is paused by the pausing unit 101, in operation 407.

However, if the user data is not correct, the resuming unit 105 does not resume the game. In this case, the method returns to operation 403 and the output unit 103 outputs the advertisement again.

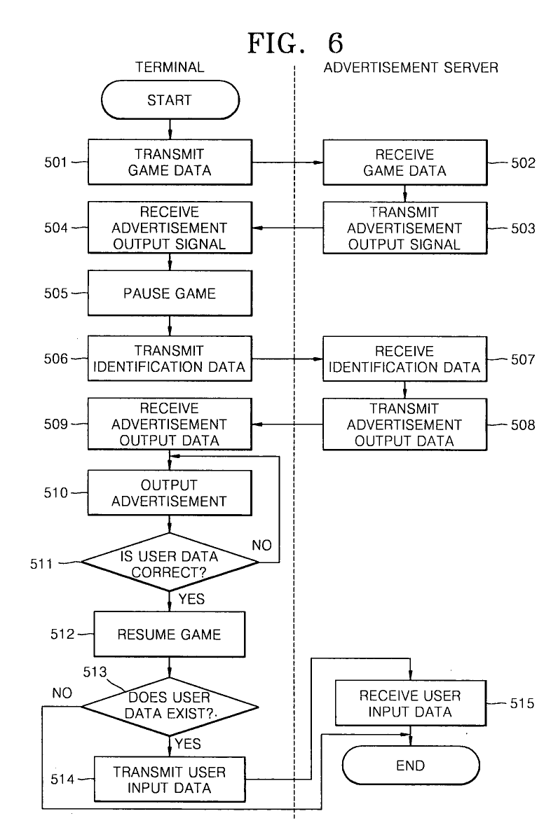

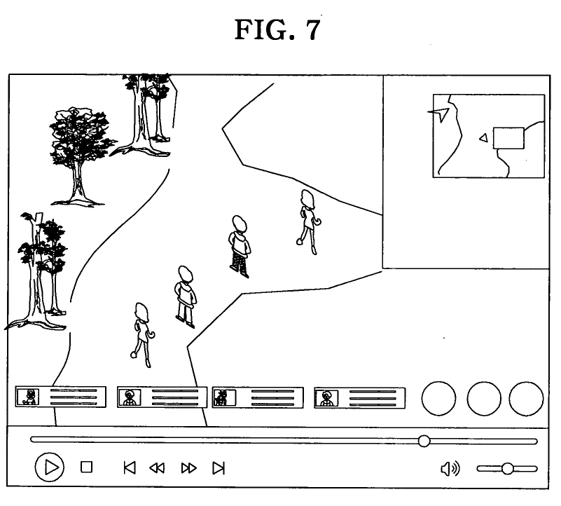

FIG. 6 is a flowchart of an advertising service providing method performed by the terminal 210 and the advertisement server 230 illustrated in FIG. 2 which provide an advertising service by cooperating with each other, according to an embodiment of the present invention. FIG. 6 will be described in conjunction with FIG. 2.

When a game is started, the game data transmission unit 214 extracts data, regarding a playing situation of the game being played in the terminal 210, from the memory 219, and transmits the data regarding the playing situation to the game data reception unit 231, in operation 501.

The data regarding the playing situation may include information regarding the actual game played time, the game played time, or temporal or spatial positions of the game.

The game data reception unit 231 transfers the data, regarding the playing situation and received from the game data transmission unit 214, to the advertisement output signal transmission unit 232, in operation 502.

If the data regarding the playing situation and received from the game data transmission unit 214 satisfies a predetermined condition that is previously stored in the database 236, the advertisement output signal transmission unit 232 transmits an advertisement output signal, indicating to pause the game being played in the terminal 210 and to output an advertisement, to the advertisement output signal reception unit 215, in operation 503.

The predetermined condition may be an output condition of the advertisement and may relate to whether a predetermined period of time is passed after the game is started, whether an important event signal of the game is generated, and whether the game reaches a point of time when chapters or sections of the game are changed.

The advertisement output signal reception unit 215 receives the advertisement output signal that is transmitted by the advertisement output signal transmission unit 232 and notifies the pausing unit 211 that the advertisement output signal is received, in operation 504.

If the advertisement output signal reception unit 215 receives the advertisement output signal from the advertisement output signal transmission unit 232 of the advertisement server 230, the pausing unit 211 pauses the game being played in the terminal 210, in operation 505.

The identification data transmission unit 216 transmits user identification data, regarding users using the game, to the identification data reception unit 233 by referring to the memory 219, in operation 506.

The identification data reception unit 233 receives the user identification data transmitted from the identification data transmission unit 216 and transfers the user identification data to the advertisement output data transmission unit 234, in operation 507.

The advertisement output data transmission unit 234 searches the database 236 for user data indicated by the user identification data that is transferred from the identification data reception unit 233.

The advertisement output data transmission unit 234 selects an advertisement in accordance with the searched user data so as to primarily output the selected advertisement on the terminal 210, or determines priorities of a plurality of advertisements and transmits data regarding the priorities of the advertisements to the advertisement output data reception unit 217 so as to output the advertisements in accordance with the priorities, in operation 508.

The advertisement output data reception unit 217 receives data, regarding the selected advertisement, or the data, regarding the priorities of the advertisements, from the advertisement output data transmission unit 234 and stores the data, regarding the selected advertisement, or the data, regarding the priorities of the advertisements, in the memory 219 or transfers the data, regarding the selected advertisement, or the data, regarding the priorities of the advertisements, to the output unit 212, in operation 509.

When the advertisement including video data is output once the game is paused by the pausing unit 211, the output unit 212 primarily outputs the selected advertisement received by the advertisement output data transmission unit 234 or outputs the advertisements in accordance with the data regarding the priorities of the advertisements and which is received by the advertisement output data transmission unit 234, in operation 510.

If the advertisement includes a dialog box for inputting user data and the user correspondingly inputs user data through the dialog box, the resuming unit 213 determines whether the user data is correct, in operation 511. If the user data is correct, the resuming unit 213 resumes the game that is paused by the pausing unit 101, in operation 512.

Otherwise, if the user data is not correct, the resuming unit 213 does not resume the game. In this case, the method returns to operation 510 and the output unit 212 outputs the advertisement again.

If the advertisement includes the dialog box for inputting user data, the user data transmission unit 218 determines whether user data input by the user using the dialog box exists, in operation 513. If the user data exists, the user data transmission unit 218 transmits the user data to the user data reception unit 235, in operation 514.

Here, the dialog box may provide questions relating to the items being advertised, an application form, or a consent form as well as additional explanation about the advertisement, or may request the user to fill the application form or the consent form.

The user data reception unit 235 receives the user data from the user data transmission unit 218, then receives the user identification data transferred from the identification data reception unit 233, and updates the user data indicated by the user identification data in accordance with the user data received from the user data transmission unit 218.

Otherwise if the user data does not exist, the method may be terminated without updating the user data, as illustrated in FIG. 6. On the other hand, in another case that the user data does not exist, the resuming unit 213 may not enable resuming of the game. Both cases are included in the technical scope of the present invention.

The resuming unit 213 resumes the game paused by the pausing unit 211 once the advertisement is completely output by the output unit 212, in operation 515.

The present invention can also be embodied as computer readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage. devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. An advertising service providing method of providing a separate video advertisement once a video game is paused, the advertising service providing method comprising:
pausing the video game in a terminal if a predetermined first condition is satisfied while the video game is being played in the terminal;
outputting an advertisement including video data once the video game is paused; and
resuming the video game once the advertisement is completely output.

2. The advertising service providing method of claim 1, further comprising:
transmitting data regarding a playing situation of the video game to an advertisement server that determines a point of time when the advertisement is to be output; and
receiving an advertisement output signal indicating to output the advertisement which is transmitted from the advertisement server if the data regarding the playing situation satisfies a predetermined second condition stored in the advertisement server,
wherein the predetermined first condition is satisfied if the advertisement output signal is received from the advertisement server.

3. The advertising service providing method of claim 1, wherein the predetermined first condition is an output condition of the advertisement that is previously stored in the terminal.

4. The advertising service providing method of claim 1, wherein the advertisement includes a dialog box for inputting user data, and
wherein the advertising service providing method further comprises:
transmitting user identification data regarding users using the video game to the advertisement server;
receiving user data of the users by using the dialog box; and
transmitting the user data to the advertisement server so as to update user data searched by using the user identification data in accordance with the user data received by using the dialog box.

5. The advertising service providing method of claim 1, further comprising:
transmitting user identification data regarding users using the video game to the advertisement server; and
receiving an advertisement from the advertisement server and which is selected in accordance with user data searched by using the user identification data, and
wherein the outputting of the advertisement comprises primarily outputting the selected advertisement.

6. The advertising service providing method of claim 1, further comprising:
transmitting user identification data regarding users using the video game to the advertisement server; and
receiving data, regarding priorities of a plurality of advertisements and which is determined in accordance with user data searched by using the user identification data, from the advertisement server, and
wherein the outputting of the advertisement comprises outputting the advertisements in accordance with the priorities.

7. The advertising service providing method of claim 1, wherein the advertisement includes a dialog box for inputting user data,
wherein the advertising service providing method further comprises receiving user data of the users by using the dialog box, and
wherein the resuming of the video game comprises resuming the video game if the user data is correct.

8. The advertising service providing method of claim 5, wherein the advertisement includes data that enables the users to access an Internet site relating to an item being advertised, and
wherein the user data includes information regarding whether the users have accessed the Internet site or information regarding purchasing inclination of the users in the Internet site.

9. An advertising service providing system for providing a separate video advertisement once a video game is paused, the advertising service providing system comprising:
a pausing unit for pausing a video game in a terminal if a predetermined first condition is satisfied while the video game is being played in the terminal;
an output unit for outputting an advertisement including video data once the video game is paused;
a resuming unit for resuming the video game once the advertisement is completely output.

10. The advertising service providing system of claim 9, further comprising:
a game data transmission unit for transmitting data regarding a playing situation of the video game to an advertisement server that determines a point of time when the advertisement is to be output; and
an advertisement output signal reception unit for receiving an advertisement output signal indicating to output the advertisement which is transmitted from the advertisement server if the data regarding the playing situation satisfies a predetermined second condition stored in the advertisement server,
wherein the predetermined first condition is satisfied if the advertisement output signal reception unit receives the advertisement output signal from the advertisement server.

11. The advertising service providing system of claim 9, wherein the predetermined first condition is an output condition of the advertisement that is previously stored in the terminal.

12. The advertising service providing system of claim 9, wherein the advertisement includes a dialog box for inputting user data, and
wherein the advertising service providing system further comprises:
an identification data transmission unit for transmitting user identification data regarding users using the video game to the advertisement server;
a user data transmission unit for transmitting user data, received by using the dialog box, to the advertisement server so as to update user data searched by using the user identification data in accordance with the user data received by using the dialog box.

13. The advertising service providing system of claim 9, further comprising:
an identification data transmission unit for transmitting user identification data regarding users using the video game to the advertisement server; and
an advertisement output data reception unit for receiving an advertisement selected in accordance with user data searched by using the user identification data from the advertisement server, and
wherein the output unit primarily outputs the selected advertisement.

14. The advertising service providing system of claim 9, further comprising:
an identification data transmission unit for transmitting user identification data regarding users using the video game to the advertisement server; and
an advertisement output data reception unit for receiving data, regarding priorities of a plurality of advertisements and which is determined in accordance with user data searched by using the user identification data, from the advertisement server, and
wherein the output unit outputs the advertisements in accordance with the priorities.

15. The advertising service providing system of claim 13, wherein the advertisement includes data that enables the users to access an Internet site relating to an item being advertised, and
wherein the user data includes information regarding whether the users have accessed the Internet site or information regarding purchasing inclination of the users in the Internet site.

16. The advertising service providing system of claim 9, wherein the advertisement includes a dialog box for inputting user data,
wherein the resuming unit resumes the video game if the user data is correct.

17. An advertising service providing system of providing a separate video advertisement once a video game is paused, the advertising service providing system comprising:
a game data reception unit for receiving data regarding a playing situation of the video game being played in a terminal, wherein the data is received from the terminal; and
an advertisement output signal transmission unit for transmitting an advertisement output signal, indicating to pause the video game and to output the advertisement by the terminal if the data regarding the playing situation satisfies a predetermined condition, to the terminal.

18. The advertising service providing system of claim 17, wherein the advertisement includes a dialog box for inputting user data, and
wherein the advertising service providing system further comprises:
an identification data reception unit for receiving user identification data, regarding users using the video game, from the terminal;
a user data reception unit for receiving user data of the users by using the dialog box from the terminal and updating user data searched by using the user identification data in accordance with the user input data.

19. The advertising service providing system of claim 17, further comprising:
an identification data reception unit for receiving user identification data, regarding users using the video game, from the terminal; and
an advertisement output data transmission unit for selecting an advertisement in accordance with user data searched by using the user identification data and transmitting the selected advertisement to the terminal so as to primarily output the selected advertisement by the terminal.

20. The advertising service providing system of claim 17, further comprising:
an identification data reception unit for receiving user identification data, regarding users using the video game, from the terminal; and
an advertisement output data transmission unit for determining priorities of a plurality of advertisements in accordance with user data searched by using the user identification data and transmitting data regarding the priorities of the advertisements to the terminal so as to output the advertisements in accordance with the priorities by the terminal.

21. The advertising service providing system of claim 19, wherein the advertisement includes data that enables the users to access an Internet site relating to an item being advertised, and
wherein the user data includes information regarding whether the users have accessed the Internet site or information regarding purchasing inclination of the users in the Internet site.

22. An advertising service providing method of providing a separate video advertisement once a video game is paused, the advertising service providing method comprising:
receiving data regarding a playing situation of the video game being played in a terminal, wherein the data is received from the terminal; and
transmitting an advertisement output signal, indicating to pause the video game and to output the advertisement by the terminal if the data regarding the playing situation satisfies a predetermined condition, to the terminal.

23. The advertising service providing method of claim 22, wherein the advertisement includes a dialog box for inputting user data, and
wherein the advertising service providing method further comprises:
receiving user identification data, regarding users using the video game, from the terminal;
receiving user data of the users by using the dialog box from the terminal and updating user data searched by using the user identification data in accordance with the user data.

24. The advertising service providing method of claim 22, further comprising:
receiving user identification data, regarding users using the video game, from the terminal; and
selecting an advertisement in accordance with user data searched by using the user identification data and transmitting the selected advertisement to the terminal so as to primarily output the selected advertisement on the terminal.

25. The advertising service providing method of claim 22, further comprising:
receiving user identification data, regarding users using the video game, from the terminal; and
determining priorities of a plurality of advertisements in accordance with user data searched by using the user identification data and transmitting data regarding the priorities of the advertisements to the terminal so as to output the advertisements in accordance with the priorities on the terminal.

26. The advertising service providing method of claim 24, wherein the advertisement includes data that enables the users to access an Internet site relating to an item being advertised, and
wherein the user data includes information regarding whether the users have accessed the Internet site or information regarding purchasing inclination of the users in the Internet site.

27. A computer readable recording medium having recorded thereon a computer readable program for executing the method of any one of claim 1.
